(19) United States
(12) Patent Application Publication
(10) Pub. No.: US 2015/0328698 A1
(43) Pub. Date: Nov. 19, 2015

(54) ROTARY TOOL HOLDER

(71) Applicant: JTEKT CORPORATION, Osaka-shi (JP)

(72) Inventors: Hisashi Otani, Anjo-shi (JP); Hiroyuki Nakano, Tokai-shi (JP); Shigeru Matsunaga, Anjo-shi (JP); Ryota Tanase, Ogaki-shi (JP)

(73) Assignee: JTEKT CORPORATION, Osaka-shi (JP)

(21) Appl. No.: 14/697,789

(22) Filed: Apr. 28, 2015

(30) Foreign Application Priority Data
May 19, 2014 (JP) 2014-102984

(51) Int. Cl. B23C 5/26; B23Q 11/00; B23C 5/28

(52) U.S. Cl. CPC B23C 5/265; B23C 5/28; B23Q 11/0032; B23C 2250/12; B23C 2250/16

(57) ABSTRACT

A rotary tool holder is provided which enables effective suppression of possible chattering vibration when a workpiece is machined using a rotary tool. A tool holder that is a rotary tool holder includes a main body that rotates while holding a rotary tool, an additional mass supported by the main body with a radial gap, a fluid path provided in the main body, and a viscoelastic damper configured by a fluid fed to the radial gap between the main body and the additional mass via the fluid path.

### INCORPORATION BY REFERENCE

The disclosure of Japanese Patent Application No. 2014-102984 filed on May 19, 2014 including the specification, drawings and abstract is incorporated herein by reference in its entirety.

### BACKGROUND OF THE INVENTION

1. Field of the Invention

The present invention relates to a rotary tool holder of a machine tool in which a rotary tool is installed.

2. Description of Related Art

As disclosed in Japanese Patent Application Publication Nos. 2012-45687 (JP 2012-45687 A) and H5-154735 (JP H5-154735), a tool holder (rotary tool holder) is conventionally known, which is attached to a spindle apparatus with a rotary tool installed in the tool holder. In both of the tool holders in JP 2012-45687 A and JP H5-154735 A, when a workpiece is machined, the machining is performed while one point on a circumference of the rotary tool is in abutting contact with the workpiece. Thus, the rotary tool and the tool holder are subjected, in a cantilever manner, to a load from a machining point on the workpiece. Consequently, chattering vibration may occur in the rotary tool and the tool holder during machining. To deal with this, Japanese Patent Application Publication No. 2012-86358 (JP 2012-86358 A) describes a method for suppressing chattering vibration described above, in which a dynamic vibration absorber is installed in the tool holder.

### SUMMARY OF THE INVENTION

An object of the present invention is to provide a rotary tool holder that allows more effective suppression of possible chattering vibration when a workpiece is machined using a rotary tool.

According to an aspect of the present invention, a rotary tool holder includes:

a main body that rotates while holding a rotary tool;

an additional mass supported by the main body with a radial gap between the additional mass and the main body;

a fluid path provided in the main body; and

a viscoelastic damper configured by the radial gap between the main body and the additional mass and a fluid fed to the radial gap via the fluid path.

Possible chattering vibration in the rotary tool holder and the rotary tool can be suppressed with the configuration in which the fluid fed through the fluid path provided in the main body forms the viscoelastic damper between the additional mass and the main body as described above. Consequently, a machining surface of a workpiece can be more accurately machined using the rotary tool. Furthermore, the rotary tool holder directly supporting the rotary tool is provided with the viscoelastic damper. Thus, possible chattering vibration in the rotary tool is more effectively suppressed.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is an axial sectional view of a spindle apparatus to which a tool holder (rotary tool holder) in a first embodiment of the present invention is applied;

FIG. 2 is an axial sectional view of the tool holder and a rotary tool in FIG. 1;

FIG. 3 is an enlarged view of a static-pressure damper portion in FIG. 2;

FIG. 4 is a graph showing a relationship between a compliance and a vibration frequency;

FIG. 5 is an axial sectional view of a tool holder in a second embodiment; and

FIG. 6 is a diagram illustrating a third embodiment.

### DETAILED DESCRIPTION OF EMBODIMENTS

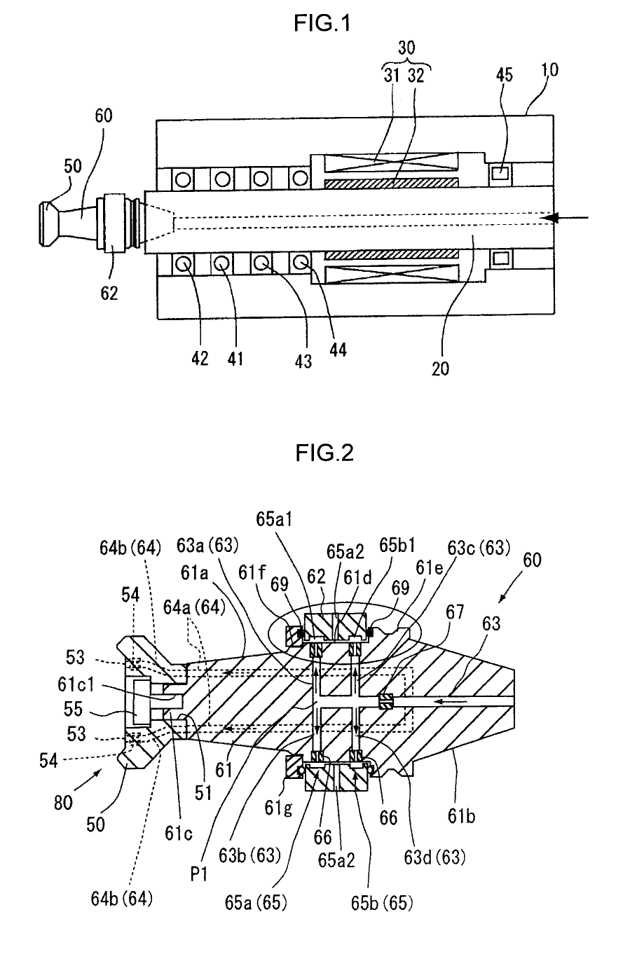

A spindle apparatus to which a rotary tool holder that is a first embodiment of the present invention is applied will be described with reference to the drawings. The rotary tool holder is hereinafter referred to as a tool holder. A configuration of the spindle apparatus will be described with reference to FIG. 1. As depicted in FIG. 1, the spindle apparatus includes a housing 10, a spindle 20, a motor 30, rolling bearings 41 to 45, a rotary tool 50, and a tool holder 60. In the present embodiment, the rotary tool 50 is a milling machine that is a rotary tool for milling. However, the milling machine is illustrated as an example, and the rotary tool 50 is not limited to the milling machine. For example, the rotary tool may be an end mill for a machining center, a pinion cutter, and a rotary tool for gear machining.

The housing 10 is formed like a hollow cylinder and the spindle 20 is arranged in the housing 10. The spindle 20 holds the tool holder 60 on a leading end side of the spindle 20 (left side in FIG. 1). The tool holder 60 holds the rotary tool 50 on a leading end side of the tool holder 60 (left side in FIG. 1). The motor 30 is arranged inside the housing 10. A stator 31 of the motor 30 is fixed to the housing 10. A rotor 32 of the motor 30 is fixed to the spindle 20.

The rolling bearings 41 to 45 support the spindle 20 with respect to the housing 10 such that the spindle 20 is rotatable. An inner peripheral surface of each of the rolling bearings 41 to 45 engages with an outer peripheral surface of the spindle 20. Each of the rolling bearings 41 to 45 is, for example, a ball bearing arranged on a rotary tool 50 side of the motor 30 (forward of the motor 30). Any type of ball bearings may be used, and for example, angular ball bearings may be used which apply pressure to the spindle 20 in an axial direction thereof. The axial direction as used herein refers to the axial direction of the spindle 20.

The rolling bearing 45 is, for example, a roller bearing arranged on the opposite side of the motor 30 from the rotary tool 50 (rearward of the rotary tool 50). In other words, the rolling bearing 45 is arranged such that the motor 30 is sandwiched between the rolling bearing 45 and the rolling bearings 41 to 44 in the axial direction. In the description of the spindle apparatus below, the left side of FIG. 1 on which the rotary tool 50 is located is referred to as a forward side, and the right side of FIG. 1 is referred to as a rearward side.

As depicted in FIG. 2, the rotary tool 50 has, in the center of a rotating shaft, a fitting hole 51 that is a through-hole. The fitting hole 51 is fitted over a protruding portion 61c of a main body 61 of the tool holder 60 described below. Furthermore, as depicted in FIG. 2, the rotary tool 50 internally has a lubricating fluid path 64b that is a part of a lubricating fluid path 64. The lubricating fluid path 64b has an opening 53 that is an outlet from the rotary tool 50. A lubricating coolant (corresponding to a fluid in the present invention) flows through the lubricating fluid path 64b. The coolant flows in a fluid feeding direction depicted by an arrow in FIG. 2. At a part of the lubricating fluid path 64b that is on the upstream side of the opening 53 in the fluid feeding direction of the coolant, a third fixed restrictor 54 is provided in which an opening (hole) with a diameter φC is formed. The third fixed restrictor 54 will be described below in detail.

As depicted in FIG. 2, the tool holder 60 includes the main body 61 (corresponding to a second component of the present invention), an additional mass 62 (corresponding to a first component of the present invention), a fluid path 63, the lubricating fluid path 64, and a static-pressure damper 65 (corresponding to a static-pressure damper and a viscoelastic damper in the present invention). The main body 61 is a member that rotates while holding the rotary tool 50. The main body 61 includes a front inclined surface 61a, a rear inclined surface 61b, the above-described protruding portion 61c, an additional mass attachment surface 61d, and an ATC chuck portion 61e. The front inclined surface 61a is formed to have an outer diameter gradually increasing from a front end surface of the main body 61 toward a central portion of the main body 61 in the axial direction. However, the maximum outer diameter of the front inclined surface 61a is formed to be smaller than the diameter of an inner peripheral surface of the additional mass 62 shaped like a ring. The rear inclined surface 61b is formed to have an outer diameter gradually increasing from a rear end surface of the main body 61 toward the central portion of the main body 61 in the axial direction. The rear inclined surface 61b is inserted and fixed in an attachment hole in the spindle 20.

In an axially central portion of an outer peripheral surface of the main body 61, an external thread portion 61f, the additional mass attachment surface 61d, and the ATC chuck portion 61e are arranged in this order from front to rear. The external thread portion 61f, the additional mass attachment surface 61d, and the ATC chuck portion 61e are formed to be different in diameter such that the outer diameter of the main body 61 increases in an order of the external thread portion 61f, the additional mass attachment surface 61d, and the ATC chuck portion 61e. A nut 61g that is a part of the main body 61 is screw-threaded over the external thread portion 61f. Specifically, the nut 61g is screw-threaded over the external thread portion 61f until the nut 61g comes into abutting contact with a side surface of a step located between the external thread portion 61f and the adjacent additional mass attachment surface 61d. An O ring groove is formed in a rear end surface of the nut 61g around the axis of the main body 61.

The axial length of the additional mass attachment surface 61d is formed to be slightly larger than the axial length of the additional mass 62 shaped like a ring. Furthermore, the maximum outer diameter of the external thread portion 61f is formed to be smaller than the inner diameter of the inner peripheral surface of the additional mass 62. Thus, the additional mass 62 can be inserted from the front end surface of the main body 61 to the additional mass attachment surface 61d.

The ATC chuck portion 61e is a portion gripped by an automatic tool changer (ATC) when the tool holder is changed. A V-shaped groove is formed in an outer peripheral surface of ATC chuck portion 61e. An O ring groove is formed in a front end surface of the ATC chuck portion 61e around the axis of the main body 61. The ATC is well known and will thus not be described in detail.

An internal thread 61c1 is formed in the center of a front end surface of the cylindrical protruding portion 61c of the main body 61. As described above, the protruding portion 61c is fitted into the fitting hole 51 formed in the rotary tool 50 (see FIG. 2). In this state, a bolt 55 is screw-threaded into the internal thread 61c1 in the protruding portion 61c from a front side of the rotary tool 50.

Then, a rear end surface of a head of the bolt 55 comes into abutting contact with a front inlet end surface of the fitting hole 51 in the rotary tool 50 so that the main body 61 and the rotary tool 50 are fixed to each other. At this time, the main body 61 and the rotary tool 50 are assembled together such that phases of the main body 61 and the rotary tool 50 coincide with each other in a rotating direction, so as to enable the lubricating fluid path 64b (a part of the lubricating fluid path 64) formed in the rotary tool 50 to be connected to the lubricating fluid path 64a (a part of the lubricating fluid path 64) formed in the main body 61 side. In the connection between the lubricating fluid path 64a and the lubricating fluid path 64b, an O ring (not shown) is used for sealing so as to prevent outward leakage from between the lubricating fluid paths 64a and 64b.

The additional mass 62 is a ring-like member as described above. The additional mass 62 is formed of, for example, an iron-containing material. When the additional mass 62 is placed around an outer peripheral surface of the additional mass attachment surface 61d of the main body 61, a radial gap is present between the outer peripheral surface of the additional mass attachment surface 61d and the inner peripheral surface of the additional mass 62. Furthermore, a slight axial gap is present, on the forward side of the additional mass 62, between the additional mass 62 and the nut 61g attached to the main body 61, and a slight axial gap is present, on the rearward side of the additional mass 62, between the additional mass 62 and the ATC chuck portion 61e, as described above.

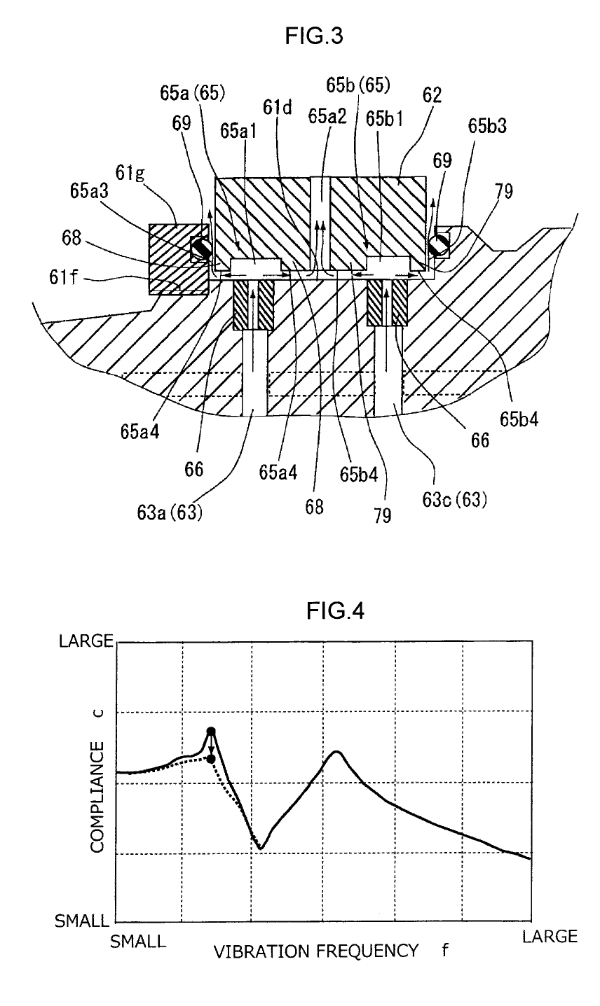

As depicted in FIG. 3, in an axial gap between an axially front end surface of the additional mass 62 and the rear end surface of the above-described nut 61g, an O ring 69 that is an elastic member is provided. The O ring 69 is housed in the O ring groove in the rear end surface of the nut 61g. Furthermore, in an axial gap between an axially rear end surface of the additional mass 62 and the front end surface of the ATC chuck portion 61e, an O ring 69 that is an elastic member is provided. The O ring 69 is housed in the O ring groove in the front end surface of the ATC chuck portion 61e.

The O rings 69 are mainly intended to prevent the front end surface of the additional mass 62 and the rear end surface of the nut 61g from coming into contact with each other and to prevent the rear end surface of the additional mass 62 and the front end surface of the ATC chuck portion 61e from coming into contact with each other. Thus, the O rings 69 are arranged in the gap between the front end surface of the additional mass 62 and the rear end surface of the nut 61g and in the gap between the rear end surface of the additional mass 62 and the front end surface of the ATC chuck portion 61e. Thus, the front and rear end surfaces of the additional mass 62 are prevented from coming into contact with the rear end surface of the nut 61g and the front end surface of the ATC chuck portion 61e, respectively. The additional mass 62 can thus make appropriate relative movement in the radial direction. The present invention is not limited to the above-described form. The front end surface of the additional mass 62 may come into slight contact with the rear end surface of the nut 61g or the rear end surface of the additional mass 62 may come into slight contact with the front end surface of the ATC chuck portion 61e.

The static-pressure damper 65 is configured by the additional mass 62 and the additional mass attachment surface 61d of the main body 61. The static-pressure damper 65 includes a first static-pressure damper 65a and a second static-pressure damper 65b. The first static-pressure damper 65a is a static-pressure damper located on a forward side in the axial direction. The second static-pressure damper 65b is a static-pressure damper located on a rearward side in the axial direction. The first static-pressure damper 65a and the second static-pressure damper 65b function as dynamic dampers when a predetermined flow rate (quantity of flow) of fluid such as coolant is fed to hydraulic pockets 65a1 and 65b1 described below.

Specifically, in the static-pressure damper 65, the fluid is fed to the hydraulic pockets 65a1 and 65b1 to exert a damping effect and a spring effect which suppresses vibration of the rotary tool 50 and the tool holder 60. The damping effect and the spring effect vary according to the flow rate of the fluid (coolant) fed to the hydraulic pockets 65a1 and 65b1. The magnitude of the damping effect is represented by a damping coefficient c. The magnitude of the spring effect is represented by a spring constant k.

The first static-pressure damper 65a and the second static-pressure damper 65b, functioning as dynamic dampers, involve a predetermined damping coefficient c and a predetermined spring constant k to suppress vibration of the main body 61 of the tool holder 60. For the predetermined damping coefficient c and the predetermined spring constant k, vibration experiments may actually be conducted to determine such predetermined values as to enables an appropriate vibration suppression effect to be produced, and the flow rate of the fluid fed to the hydraulic pockets 65a1 and 65b1 may be set so as to achieve the predetermined values.

A solid graph in FIG. 4 illustrates the vibration frequency f and compliance C of an integral member 80 of the rotary tool 50 and the tool holder 60 in a case where, for example, the static-pressure damper 65 is not provided. In FIG. 4, the vibration frequency f is a vibration frequency occurring when the integral member 80 machines a workpiece (not shown). The compliance C is determined in accordance with

Expression 1:

C=Δx/F (1)

where C: compliance, Δx: displacement of the integral member 80 at the time of vibration, and F: imposed load.

A dashed graph in FIG. 4 represents a vibration frequency f-compliance C property observed when a predetermined flow rate of the coolant is fed to the static-pressure damper 65 (first and second static-pressure dampers 65a and 65b). A comparison of the dashed graph with the solid graph indicates that the compliance C at a peak frequency decreases (see arrow). The predetermined flow rate is the flow rate at which the predetermined damping coefficient c and the predetermined spring constant k are obtained as described above. Thus, vibration of the integral member 80 is suppressed to improve the accuracy of a machined surface of the workpiece. The first and second static-pressure dampers 65a and 65b may be changed to other viscoelastic dampers such as pneumatic static dampers, magnetic dampers, or dampers using rubber O rings.

In the present embodiment, the first static-pressure damper 65a and the second static-pressure damper 65b have similar configurations. Hence, the damping coefficients c of the first and second static-pressure dampers 65a and 65b are the same, and the spring constants k of the first and second static-pressure dampers 65a and 65b are the same.

The fluid path 63 is a channel through which the coolant is fed to the first and second static-pressure damper 65a and 65b and is provided as depicted in FIG. 2. The fluid path 63 is connected to an outlet of an oil pump (not shown) and arranged rearward of (to the right of) the fluid path 63 in FIG. 2. The oil pump is, for example, a pump that can discharge the coolant at a discharge pressure of 2 MPs. The fluid path 63 is disposed to enable the coolant to be fed to each of the hydraulic pockets 65a1 and 65b1 in the first and second static-pressure dampers 65a and 65b, respectively (see FIG. 2). As depicted in FIG. 2, branch channels 63a, 63b, 63c, and 63d forming the fluid path 63 are provided to enable the coolant to be fed to each of the hydraulic pockets 65a1 and 65b1. The branch channels 63a and 63b are separated from each other by 180 degrees in a circumferential direction around the axis. The branch channels 63c and 63d are separated from each other by 180 degrees in the circumferential direction around the axis. However, the present invention is not limited to this form. Three or more branch channels may be provided in the circumferential direction around the axis. Alternatively, a single branch channel may be provided.

In the fluid path 63, first fixed restrictors 66 are provided on immediate upstream sides of the first and second static-pressure dampers 65a and 65b (viscoelastic dampers). The first fixed restrictors 66 are formed in accordance with the amount of the coolant fed to the first and second static-pressure dampers 65a and 65b through the fluid path 63 (branch channels 63a, 63b, 63c, and 63d). In other words, the first fixed restrictors 66 each with an opening of a predetermined diameter φA are formed in order to allow the first and second static-pressure dampers 65a and 65b to obtain an intended flow rate of the coolant needed to achieve the predetermined damping coefficient c and the predetermined spring constant k. The flow rate of the coolant fed to each of the first and second static-pressure dampers 65a and 65b through the first fixed restrictor 66 is determined based on a pressure P1 on the upstream side, in the fluid feeding direction, of the first fixed restrictor 66 in the fluid path 63 (branch channels 63a, 63b, 63c, and 63d) and the diameter φA of the opening in the first fixed restrictor 66.

The fluid path 63 is provided with the second fixed restrictor 67 on the upstream side of a branch point where the branch channels 63c and 63d branch from the fluid path 63 in the fluid feeding direction (depicted by an arrow in the fluid path in FIG. 2). The second fixed restrictor 67 is a restrictor provided to adjust a coolant pressure measured upstream of the first fixed restrictor 66 to the above-described pressure P1. Hence, the second fixed restrictor 67 has an opening diameter φB needed to reduce the pressure of 2 MPa of the coolant discharged from a pump (not shown) to the pressure P1.

The lubricating fluid path 64 is provided as depicted in FIG. 2. It is not possible to depict the lubricating fluid path 64 on the same cross section as that including the fluid path 63, and thus, the lubricating fluid path 64 is depicted by a dashed line. The lubricating fluid path 64 is a channel through which the coolant is fed to a machining point for the rotary tool 50. The lubricating fluid path 64 branches from the fluid path 63 on the upstream side of the first fixed restrictors 66 in the fluid feeding direction (see an arrow in the fluid path 63 in FIG. 2).

The lubricating fluid path 64 communicates through the main body 61 of the tool holder 60 to the front end surface of the main body 61. The lubricating fluid path 64 communicating to the front end surface of the main body 61 is referred to as a lubricating fluid path 64a. The phase of the lubricating fluid path 64a is matched with the phase of the lubricating fluid path 64b formed in the rotary tool 50 as described above to connect the channel of the lubricating fluid path 64a to the channel of the lubricating fluid path 64b. Thus, the coolant flowing through the lubricating fluid path 64 reaches the opening 53 in the rotary tool 50 and is ejected and fed through the opening 53 to the machining point.

As described above, the third fixed restrictor 54 with the opening diameter φC is provided on the lubricating fluid path 64a on the upstream side of the opening 53 in the feeding direction of the coolant. The diameter φC of the opening in the third fixed restrictor 54 is an opening diameter that enables an intended amount (needed amount) of the coolant to flow through the fluid path 63. In other words, an excessively large diameter φC of the opening in the third fixed restrictor 54 precludes a needed flow rate of the coolant from being fed to the first and second static-pressure dampers 65a and 65b via the fluid path 63 (in other words, the branch channels 63a, 63b, 63c, and 63d). Thus, the diameter φC of the opening in the third fixed restrictor 54 is set to a diameter value that enables a sufficient amount of the coolant to be fed to the machining point through the opening 53, while enabling the needed flow rate of the coolant to be fed to the first and second static-pressure dampers 65a and 65b via the fluid path 63.

A configuration of the static-pressure damper 65 will be described based on FIG. 2 and FIG. 3. As described above, the static-pressure damper 65 has the first and second static-pressure dampers 65a and 65b, which are formed to have the same configuration. Thus, the static-pressure damper will be described using the first static-pressure damper 65a. As depicted in FIG. 2 and FIG. 3, the first static-pressure damper 65a has the hydraulic pocket 65a1, a first drain passage 65a2, a second drain passage 65a3, an opposite surface 65a4 formed on the additional mass 62, the additional mass attachment surface 61d that is an opposite surface formed on the main body 61, the branch channel 63a (part of the fluid path 63) through which the coolant is fed, and the first fixed restrictor 66. The branch channel 63a and the first fixed restrictor 66 are configured as described above.

The hydraulic pocket 65a1 is formed in the inner peripheral surface of the additional mass 62 (first component), which faces the outer peripheral surface of the additional mass attachment surface 61d of the main body 61 (second component). The hydraulic pocket 65a1 is engraved in the inner peripheral surface of the additional mass 62 in a recessed form so as to extend over the entire circumference. The first drain passage 65a2 is provided in the additional mass 62 at a position midway between the first static-pressure damper 65a and the second static-pressure damper 65b in the axial direction so as to penetrate the additional mass 62 from the outer peripheral surface to the inner peripheral surface thereof in the radial direction. The first drain passage 65a2 is shared by the first static-pressure damper 65a and the second static-pressure damper 65b. Walls 68 are provided at axially opposite ends of the hydraulic pocket 65a1. On the inner peripheral surfaces of both walls 68, the above-described opposite surface 65a4 is provided facing the outer peripheral surface of the additional mass attachment surface 61d. The opposite surface 65a4 and the additional mass attachment surface 61d face each other with a slight gap therebetween. The gap forms a channel through which the coolant fed to the hydraulic pocket 65a1 flows from the hydraulic pocket 65a1 toward the first drain passage 65a2 and the second drain passage 65a3 described below.

The second drain passage 65a3 is formed forward of the hydraulic pocket 65a1 via the front wall 68 in the axial direction. In other words, the second drain passage 65a3 is defined by the space between the end surface of the nut 61g and the front end surface of the additional mass 62 and the space (gap) between front end surface of the additional mass 62 and the O ring 69. A second drain passage 65b3 in the second static-pressure damper 65b is defined by the space between the rear end surface of the additional mass 62 and the end surface of the ATC chuck portion 61e and the space (gap) between rear end surface of the additional mass 62 and the O ring 69.

The coolant flowing through the hydraulic pocket 65a1, the first drain passage 65a2, and the second drain passage 65a3 may be discharged to the exterior of the tool holder 60. Furthermore, the present invention is not limited to this form. The first drain passage 65a2 and the second drain passage 65a3 may be connected to a drain collection passage (not shown) so that the coolant may be collected in a reservoir (not shown).

As described above, the second static-pressure damper 65b has a configuration similar to the configuration of the first static-pressure damper 65a. In other words, the hydraulic pocket 65a1, the first drain passage 65a2 (shared), the second drain passage 65a3, the opposite surface 65a4, the additional mass attachment surface 61d (opposite surface), the branch channel 63a, the first fixed restrictor 66, and the walls 68 provided in the first static-pressure damper 65a correspond to the hydraulic pocket 65b1, the first drain passage 65a2, the second drain passage 65b3, an opposite surface 65b4, the additional mass attachment surface 61d (opposite surface), the branch channel 63c, the first fixed restrictor 66, and walls 79 provided in the second static-pressure damper 65b. As described above, the O ring 69, which is an elastic member, is installed between the axially front end surface of the additional mass 62 and the rear end surface of the above-described nut 61g, and the gap between the O ring 69 and the front end surface of the additional mass 62 forms the second drain passage 65a3. Furthermore, the O ring 69, which is an elastic member, is installed between the axially rear end surface of the additional mass 62 and the front end surface of the ATC chuck portion 61e, and the gap between the O ring 69 and the rear end surface of the additional mass 62 forms the second drain passage 65b3.

An operation will be described which is performed when a workpiece is machined using the spindle apparatus configured as described above and the rotary tool 50 held by the tool holder 60.

When machining is started, a hydraulic pump is actuated to feed the coolant (lubricant) to the machining point on the workpiece. The hydraulic pump feeds, for example, the coolant with an oil pressure of 2 MPa to the fluid path 63. The coolant flowing through the fluid path 63 flows into the lubricating fluid path 64a (a part of the lubricating fluid path 64) branching from the middle of the fluid path 63.

The coolant having flown into the lubricating fluid path 64 reaches the opening 53 via the lubricating fluid path 64a formed in the main body 61, the lubricating fluid path 64b formed in the rotary tool 50, and the third fixed restrictor 54 formed on the lubricating fluid path 64b. The amount of the coolant ejected through the opening 53 is determined based on the discharge pressure of the hydraulic pump and the diameter 4C of the opening in the third fixed restrictor 54. A predetermined amount of the coolant ejected through the opening 53 is fed to the machining point, which is thus appropriately lubricated and cooled.

In the above description, all of the coolant discharged into the fluid path 63 by the hydraulic pump except for a portion thereof having flown into the lubricating fluid path 64 flows into the branch channels 63a, 63b, 63c, and 63d of the fluid path 63 via the second fixed restrictor 67. The amount of the coolant flowing into the branch channels 63a, 63b, 63c, and 63d is determined based on the diameter φB of the opening in the second fixed restrictor 67 and the diameter φC of the opening in the third fixed restrictor 54 provided in the rotary tool 50. An excessively large diameter φC of the opening in the third fixed restrictor 54 may cause a large amount of the coolant to flow into the lubricating fluid path 64, with the result that a reduced amount of the coolant flows into the remaining branch channels 63a, 63b, 63c, and 63d.

However, in the present embodiment, the diameter φC of the opening in the third fixed restrictor 54 is set so as to allow a needed (intended) amount of the coolant to flow into the branch channels 63a, 63b, 63c, and 63d of the fluid path 63. Thus, the needed amount of the coolant flows into the branch channels 63a, 63b, 63c, and 63d. Then, the pressure between the first fixed restrictor 66 and the second fixed restrictor 67 is set to the intended pressure P1 by the effect of the first fixed restrictor 66 provided on the upstream side of the static-pressure damper 65 in the fluid feeding direction and having the opening diameter φA and the second fixed restrictor 67 having the opening diameter φB.

Thus, the coolant is pushed out from the first fixed restrictor 66 toward the static-pressure damper 65 (first static-pressure damper 65a and second static-pressure damper 65b) at the intended pressure and flows at the intended flow rate. Then, the coolant having been fed to the hydraulic pockets 65a1 and 65b1 in the static-pressure damper 65 (first static-pressure damper 65a and second static-pressure damper 65b) passes, at an appropriate flow rate, through the gap between the opposite surface 65a4 and the additional mass attachment surface 61d, which is formed on each of the axially opposite sides of the hydraulic pocket 65a1, and the gap between the opposite surface 65a4 and the additional mass attachment surface 61d, which is formed on each of the axially opposite sides of the hydraulic pocket 65b1. Subsequently, the coolant passes through the first drain passage 65a2 (shared), the second drain passage 65a3, the and second drain passage 65b3 and is then discharged to the exterior of the tool holder 60. Thus, the static-pressure damper 65 is provided with the appropriate damping coefficient c and spring constant k, allowing possible chattering vibration to be appropriately suppressed when the rotary tool 50 machines the workpiece (see the dashed graph in FIG. 3).

As is well known, when possible chattering vibration in the main body 61 (rotary tool 50) of the tool holder 60 is suppressed using the first and second static-pressure dampers 65a and 65b as described above, certain ranges of the damping coefficient c and the spring constant k enable the vibration to be most efficiently suppressed depending on the shapes, materials, weights, and the like of the rotary tool 50 and the main body 61 and also of the spindle 20 and the like. Hence, the first and second static-pressure dampers 65a and 65b are preferably fed with oil at a flow rate and a pressure suitable for achieving the ranges of the damping coefficient c and the spring constant k which allow a high vibration suppression effect to be produced. However, the first and second static-pressure dampers 65a and 65b may be fed simply with oil at a predetermined flow rate and a predetermined pressure so as to achieve only the range of the damping coefficient c which allows a high vibration suppression effect to be produced, without taking the spring constant k into account.

The tool holder 60 in the first embodiment includes the main body 61 that rotates while holding the rotary tool 50, the additional mass 62 which is held by the main body 61 via the gap extending in the radial direction of the main body 61 and which rotates along with the main body 61, the fluid path 63 provided in the main body 61, and the static-pressure damper 65 (viscoelastic damper) formed of the coolant (fluid) fed to the radial gap between the main body 61 and the additional mass 62 via the fluid path 63. Thus, possible chattering vibration in the tool holder 60 and the rotary tool 50 can be suppressed by the configuration in which the static-pressure damper 65 (viscoelastic damper) is formed between the additional mass 62 and the main body 61 by the coolant fed through the fluid path 63 provided in the main body 61. Consequently, a machining surface of the workpiece is more accurately machined. Furthermore, since the static-pressure damper 65 (viscoelastic damper) is provided in the tool holder 60 that supports the rotary tool 50, possible chattering vibration in the rotary tool 50 is effectively suppressed.

According to the first embodiment, the viscoelastic damper is the static-pressure damper 65 (static-pressure fluid damper) in which the hydraulic pockets 65a1 and 65b1 are provided between the outer peripheral surface of the main body 61 and the inner peripheral surface of the additional mass 62. Thus, when possible chattering vibration in the tool holder 60 and the rotary tool 50 is suppressed, the amount of the coolant fed to the static-pressure damper 65 is adjusted to allow easy achievement of the damping coefficient c and spring constant k most suitable for the tool holder 60 and the rotary tool 50.

According to the first embodiment, on the upstream side of the static-pressure damper 65 (viscoelastic damper) in the fluid path 63 in the fluid feeding direction, the first fixed restrictor 66 is provided, which is configured to set the amount of the coolant (fluid) fed to the static-pressure damper 65 through the fluid path 63 to the intended value. This simple and inexpensive method of providing the first fixed restrictor 66 allows control of the amount of the coolant (fluid) fed to the static-pressure damper 65.

According to the first embodiment, on the fluid path 63, the second fixed restrictor 67 is provided, which is configured to set the pressure in an area located in the branch channels 63a, 63b, 63c, and 63d and upstream of the first fixed restrictor 66, to the preset pressure P1. Thus, the preset pressure P1 allows a constant amount of the coolant (fluid) to be always fed to the static-pressure damper 65 via the first fixed restrictor 66, stably suppressing possible chattering vibration in the tool holder 60 and the rotary tool 50.

According to the first embodiment, one type of coolant is fed from the common hydraulic pump to the static-pressure damper 65 (viscoelastic damper) to suppress possible chattering vibration in the tool holder 60 and the rotary tool 50, while lubricating and cooling the machining point on the workpiece. This eliminates the need to newly provide a facility for the fluid fed to the static-pressure damper 65 and is thus efficient. Furthermore, routing of the lubricating fluid path 64 is complete within the main body 61 of the tool holder 60. This eliminates the need to provide a new pipe outside the main body 61, resulting in space saving.

According to the first embodiment, on the upstream side of the opening 53 in the lubricating fluid path 64 in the fluid feeding direction, the third fixed restrictor 54 is provided, which is configured to set the amount of the coolant (fluid) fed to the fluid path 63 branching from the lubricating fluid path 64, to the intended amount. Consequently, a needed amount (intended amount) of the coolant (fluid) is distributed to the fluid path 63 in a simple and reliable manner. Furthermore, the amount of the fluid fed to the machining point through the opening 53 can be controlled in a simple manner.

According to the first embodiment, the O ring that is an elastic member is arranged in the axial gap between the additional mass 62 and the main body 61. Thus, the inexpensive O ring allows the additional mass 62 to be appropriately prevented from coming into contact with the nuts 61g and the ATC chuck portion 61e.

Now, a second embodiment of the present invention will be described based on FIG. 5. The second embodiment is different from the first embodiment only in that an additional mass 162 included in a tool holder 160 is installed inside a main body 161 rather than at an outer periphery of the main body 161. Hence, only differences from the first embodiment will be described, and detailed description of similar elements is omitted. Furthermore, in the description, the same components are denoted by the same reference numerals.

As depicted in FIG. 5, the tool holder 160 includes the main body 161 (corresponding to a first component of the present invention), an additional mass 162 (corresponding to a second component of the present invention), a fluid path 163, a lubricating fluid path 164, and a static-pressure damper 165 (corresponding to a static-pressure fluid damper and a viscoelastic damper in the present invention). The main body 161 includes a rear inclined surface 61b, an additional mass insertion hole 161d, and an ATC chuck portion 61e.

A protruding and interposed portion 161c corresponding to a protruding portion 61c in the first embodiment is provided between the tool holder 160 and the rotary tool 150. In the tool holder 160 in the second embodiment, the additional mass 162 is inserted into the additional mass insertion hole 161d formed inside the main body 161. The additional mass 162 is sealed inside the additional mass insertion hole 161d closed by a rear end surface of the protruding and interposed portion 161c. Between the additional mass 162 and the additional mass insertion hole 161d, a gap is present in each of the axial and radial directions. An O ring 169 that is an elastic member is interposed in the axial gap between an axially front end surface of the additional mass 162 and a rear end surface of the protruding and interposed portion 161c. Furthermore, an O ring 169 that is an elastic member is interposed between an axially rear end surface of the additional mass 162 and a bottom surface of the additional mass insertion hole 161d. The O rings 169 may be compressively interposed or interposed without being compressed so as to form a gap.

The fluid path 163 is provided around the axial center of the main body 161 and the additional mass 162. Four through-holes are formed in the fluid path 163 in the additional mass 162 so as to extend from the fluid path 163 toward a radial outside of the additional mass 162. The four through-holes form branch channels 163a to 163d. A first fixed restrictor 166 is provided in each of the branch channels 163a to 163d. Hydraulic pockets 165a1 and 165b1 are formed in an outer periphery of the first fixed restrictors 166 and connect to the branch channels 163a to 163d.

The hydraulic pockets 165a1 and 165b1 are engraved so as to extend over the entire circumference of the additional mass 162 (corresponding to a second component of the present invention). Between the hydraulic pockets 165a1 and 165b1 in the outer peripheral surface of the additional mass 162, an outer peripheral groove 165d is engraved so as to extend over the entire circumference. Furthermore, at a position forward (leftward in FIG. 5) of the hydraulic pocket 165a1 in the outer peripheral surface of the additional mass 162, an outer peripheral groove 165c is engraved so as to extend over the entire circumference. Moreover, at a position rearward (rightward in FIG. 5) of the hydraulic pocket 165b1 in the outer peripheral surface of the additional mass 162, an outer peripheral groove 165e is engraved so as to extend over the entire circumference.

A wall 168 is formed on the additional mass 162 between the hydraulic pocket 165a1 and the outer peripheral groove 165c. Another wall 168 is formed on the additional mass 162 between the hydraulic pocket 165a1 and the outer peripheral groove 165d. Further, a wall 179 is formed on the additional mass 162 between the outer peripheral groove 165d and the hydraulic pocket 165b1. Another wall 179 is formed on the additional mass 162 between the hydraulic pocket 165b1 and the outer peripheral groove 165e. Spaces enclosed by the outer peripheral grooves 165c to 165e and an inner peripheral surface of the additional mass insertion hole 161d form drain passages. Each of the drain passages is connected, at one position on the circumference, to a discharge drain passage 161h provided in the main body 161 and the protruding and interposed portion 161c (see FIG. 5).

The static-pressure damper 165 (first static-pressure damper 165a and second static-pressure damper 165b) is configured by the above-described hydraulic pockets 165a1 and 165b1, the inner peripheral surface of the additional mass insertion hole 161d (opposite surface), and the walls 168, 168, 179, and 179, and the like. A coolant fed to static-pressure damper 165 is discharged to the exterior of the tool holder 160 via the drain passages defined by the outer peripheral grooves 165c to 165e and the discharge drain passage 161h.

The lubricating fluid path 164, the second fixed restrictor 167, and the third fixed restrictor 154 are formed as is the case with the first embodiment. The second embodiment is different from the first embodiment only in that the protruding and interposed portion 161c is interposed between the main body 161 and the rotary tool 150. This configuration allows effects similar to those of the first embodiment to be exerted.

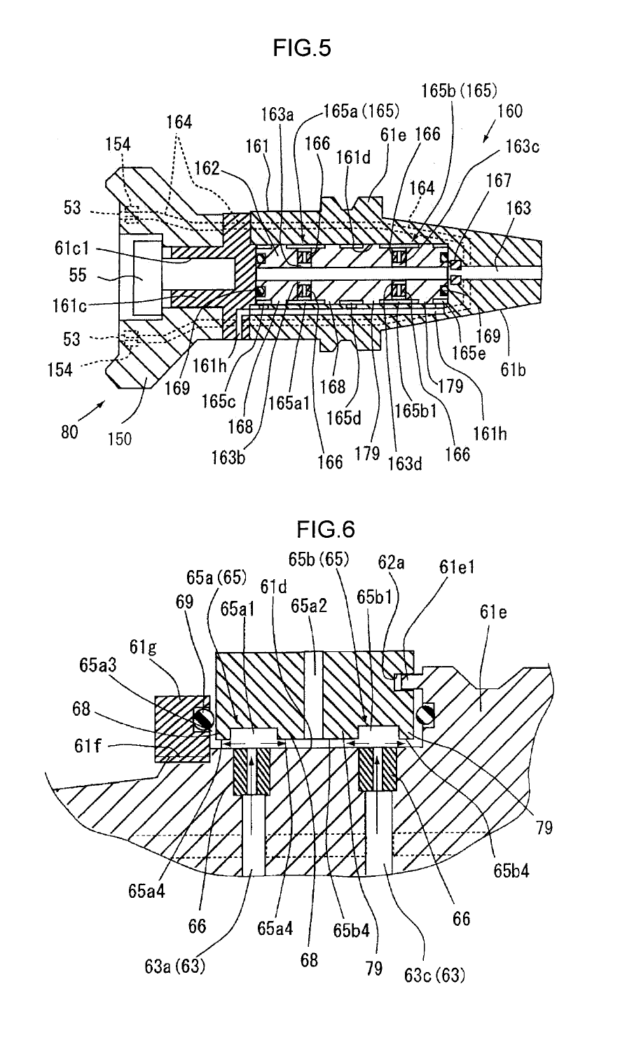

In the first and second embodiments, the gap is formed between each of the additional masses 62 and 162 and the corresponding one of the main bodies 61 and 161, and only the O ring is interposed in the gap. However, the present invention is not limited to this form. In the third embodiment, as depicted in FIG. 6, a recessed portion 62a for locking may be formed in the rear end surface of the additional mass 62, and a protruding portion 61e1 that is fitted into the recessed portion 62a may be formed in the front end surface of the ATC chuck portion 61e. The configuration except for the recessed portion 62a and the protruding portion 61e1 is based on the first embodiment. This configuration regulates relative rotation of the additional mass 62 and the main body 61 with the ATC chuck portion 61e in the circumferential direction. Thus, contact portions between the additional mass 62 and the ATC chuck portion 61e and the nut are prevented from being worn off as a result of the relative rotation. A method for regulating the relative rotation of the additional mass 62 and the main body 61 is not limited to the above-described form but any method may be used.

In the first to third embodiments, the viscoelastic damper is the static-pressure damper 65 or 165 having the hydraulic pockets 65a1 and 65b1 or 165a1 and 165b1, respectively. However, the present invention is not limited to this form. The static-pressure damper 65 or 165 may be a gap that is formed between cylindrical surfaces and does not have the hydraulic pockets 65a1 and 65b1 or 165a1 and 165b1. This also produces commensurate effects.

In the first to third embodiments, the static-pressure damper 65 or 165 includes two, front and rear static-pressure dampers, that is, the first and second static-pressure dampers 65a and 65b or the first and second static-pressure dampers 165a and 165b, respectively. However, the present invention is not limited to this form. The static-pressure damper 65 or 165 may be a single static-pressure damper. This also produces a commensurate vibration suppression effect.

In the first to third embodiments, the lubricating fluid path 64 is provided along with the fluid path 63 or 163. However, the present invention is not limited to this form. The lubricating fluid path 64 may be omitted. This also produces a commensurate vibration suppression effect.

In the first to third embodiments, the first to third fixed restrictors are provided. However, the present invention is not limited to this form. The second and third fixed restrictors may be omitted. In this case, the discharge pressure of the oil pump may be adjusted to the pressure P1. This allows exertion of a vibration suppression effect similar to the vibration suppression effect in the first to third embodiments.

In the first to third embodiments, the O ring 69 is arranged between the front end surface of the additional mass 62 and the rear end surface of the nut 61g and between the rear end surface of the additional mass 62 and the front end surface of the ATC chuck portion 61e. Moreover, a slight gap is formed between the O ring 69 and the adjacent end surface. However, the present invention is not limited to this form. The O ring 69 may be compressively interposed between the front end surface of the additional mass 62 and the rear end surface of the nut 61g and between the rear end surface of the additional mass 62 and the front end surface of the ATC chuck portion 61e. This is also expected to produce a commensurate vibration suppression effect.

Further, when O ring 69 is compressively interposed as described above, an axial through-hole may be formed in the nut 61g and the ATC chuck portion 61e. The through-hole functions as a drain passage through which the coolant is discharged from the static-pressure damper. In the nut 61g, the through-hole extends from the front end surface of the nut 61g to the space between the nut 61g and the front end surface of the additional mass 62 so as to penetrate the nut 61g. In the ATC chuck portion 61e, the through-hole extends from the rear end surface of the ATC chuck portion 61e to the space between the rear end surface of the additional mass 62 and the front end surface of the ATC chuck portion 61e so as to penetrate the ATC chuck portion 61e. This is also expected to produce effects similar to the effects of the first to third embodiments.

Moreover, in the description of the first to third embodiments, the tool holder 60 or 160 is a holder for the rotary tool. Moreover, for a spindle of a type that directly supports the rotary tool, the present invention may be applied to implement a new embodiment in which the spindle serves as a rotary tool holder. This also produces effects similar to the above-described effects.

What is claimed is:

1. A rotary tool holder comprising:
a main body that rotates while holding a rotary tool;
an additional mass supported by the main body with a radial gap between the additional mass and the main body;
a fluid path provided in the main body; and
a viscoelastic damper configured by the radial gap between the main body and the additional mass and a fluid fed to the radial gap via the fluid path.

2. The rotary tool holder according to claim 1, wherein
the additional mass is provided so that a radial gap and an axial gap are formed between the additional mass and the main body.

3. The rotary tool holder according to claim 1, wherein
the viscoelastic damper is a static-pressure fluid damper including, when the main body and the additional mass are represented as either of a first component or a second component, a hydraulic pocket formed in one of an inner peripheral surface of the first component or an outer peripheral surface of the second component.

4. The rotary tool holder according to claim 2, wherein
the viscoelastic damper is a static-pressure fluid damper including, when the main body and the additional mass are represented as either of a first component or a second component, a hydraulic pocket formed in one of an inner peripheral surface of the first component or an outer peripheral surface of the second component.

5. The rotary tool holder according to claim 2, wherein
an elastic member is provided in the axial gap between the additional mass and the main body.

6. The rotary tool holder according to claim 3, wherein
an elastic member is provided in the axial gap between the additional mass and the main body.

7. The rotary tool holder according to claim 4, wherein
an elastic member is provided in the axial gap between the additional mass and the main body.

8. The rotary tool holder according to claim 1, wherein
the fluid path includes a first fixed restrictor configured to set a flow rate of the fluid fed to the viscoelastic damper to an intended flow rate.

9. The rotary tool holder according to claim 2, wherein
the fluid path includes a first fixed restrictor configured to set a flow rate of the fluid fed to the viscoelastic damper to an intended flow rate.

10. The rotary tool holder according to claim 3, wherein
the fluid path includes a first fixed restrictor configured to set a flow rate of the fluid fed to the viscoelastic damper to an intended flow rate.

11. The rotary tool holder according to claim 5, wherein
the fluid path includes a first fixed restrictor configured to set a flow rate of the fluid fed to the viscoelastic damper to an intended flow rate.

12. The rotary tool holder according to claim 8, wherein
the fluid path includes a second fixed restrictor formed on an upstream side of the first fixed restrictor, and
the second fixed restrictor is configured to set equal to a preset pressure a pressure in the fluid path between the second fixed restrictor and the first fixed restrictor in the fluid path.

13. The rotary tool holder according to claim 12, wherein
in the main body, a lubricating fluid path is provided, which branches from the fluid path at a point on an upstream side of the second fixed restrictor, and
the lubricating fluid path extends through the main body and the rotary tool so that the fluid is fed to a machining point through an opening formed in the rotary tool.

14. The rotary tool holder according to claim 13, wherein
a third fixed restrictor is provided on an upstream side of the opening in the lubricating fluid path, and
the third fixed restrictor is configured to set the flow rate of the fluid fed to the fluid path connected to the lubricating fluid path, to an intended flow rate.

15. The rotary tool holder according to claim 1, wherein
when the main body and the additional mass are represented as either of a first component or a second component, the first component includes a recessed portion for locking, and the second component includes a protruding portion for locking which is fitted into the recessed portion, and
the first component is fixed to the second component so as to be non-rotatable.

16. The rotary tool holder according to claim 2, wherein
when the main body and the additional mass are represented as either of a first component or a second component, the first component includes a recessed portion for locking, and the second component includes a protruding portion for locking which is fitted into the recessed portion, and
the first component is fixed to the second component so as to be non-rotatable.

17. The rotary tool holder according to claim 3, wherein
when the main body and the additional mass are represented as either of a first component or a second component, the first component includes a recessed portion for locking, and the second component includes a protruding portion for locking which is fitted into the recessed portion, and
the first component is fixed to the second component so as to be non-rotatable.

18. The rotary tool holder according to claim 5, wherein
when the main body and the additional mass are represented as either of a first component or a second component, the first component includes a recessed portion for locking, and the second component includes a protruding portion for locking which is fitted into the recessed portion, and
the first component is fixed to the second component so as to be non-rotatable.

19. The rotary tool holder according to claim 8, wherein
when the main body and the additional mass are represented as either of a first component or a second component, the first component includes a recessed portion for locking, and the second component includes a protruding portion for locking which is fitted into the recessed portion, and
the first component is fixed to the second component so as to be non-rotatable.

20. The rotary tool holder according to claim 12, wherein
when the main body and the additional mass are represented as either of a first component or a second component, the first component includes a recessed portion for locking, and the second component includes a protruding portion for locking which is fitted into the recessed portion, and
the first component is fixed to the second component so as to be non-rotatable.
